(19) United States
(12) Patent Application Publication
(10) Pub. No.: US 2021/0380457 A1
(43) Pub. Date: Dec. 9, 2021

(54) GLASS FORMING APPARATUSES HAVING INJECTION AND EXTRACTION PORTS AND METHODS OF COOLING GLASS USING THE SAME

(71) Applicant: CORNING INCORPORATED, CORNING, NY (US)

(72) Inventor: Anmol Agrawal, Horseheads, NY (US)

(21) Appl. No.: 17/281,764

(22) PCT Filed: Oct. 1, 2019
(86) PCT No.: PCT/US2019/053940

§ 371 Date: Mar. 31, 2021

Related U.S. Application Data
(60) Provisional application No. 62/741,767, filed on Oct. 5, 2018.

(51) Int. Cl. C03B 17/06; C03B 15/12

(52) U.S. Cl. CPC C03B 17/067; C03B 15/12; C03B 17/064

(57) ABSTRACT

Glass forming apparatuses which decrease dimensional variations in glass ribbons are disclosed. In embodiments, a glass forming apparatus may include a forming body defining a draw plane that extends in a draw direction. An enclosure may extend in the draw direction below the forming body. The enclosure may include a compartment positioned below the forming body in the draw direction. The compartment may include a cooled wall positioned adjacent to the draw plane, a fluid conduit positioned within the compartment and adjacent to the cooled wall, an extraction port extending through the cooled wall and positioned in the draw direction from the fluid conduit, and an injection port extending through the cooled wall and positioned in the draw direction from the fluid conduit.

### CROSS-REFERENCE TO RELATED APPLICATIONS

This application claims the benefit of priority of U.S. Provisional Application Ser. No. 62/741,767 filed on Oct. 5, 2018 the contents of which are relied upon and incorporated herein by reference in their entirety as if fully set forth below.

### FIELD

The present specification generally relates to glass forming apparatuses used in glass manufacturing operations and, in particular, to glass forming apparatuses comprising extraction and injection ports that modify temperatures of air within the glass forming apparatus.

### BACKGROUND

Glass substrates, such as cover glasses, glass backplanes and the like, are commonly employed in both consumer and commercial electronic devices such as LCD and LED displays, computer monitors, automated teller machines (ATMs) and the like. Various manufacturing techniques may be utilized to form molten glass into ribbons of glass which, in turn, are segmented into discrete glass substrates for incorporation into such devices. These manufacturing techniques include, for example and without limitation, down draw processes such as slot draw processes and fusion forming processes, updraw processes, and float processes.

Regardless of the process used, deviations in the width and/or thickness of the glass ribbon may decrease manufacturing through-put and/or increase manufacturing costs as portions of the glass ribbon with deviations in the width and/or thickness are discarded as waste glass.

Accordingly, a need exists for glass forming apparatus and methods for forming glass ribbons which mitigate deviations in the width and/or thickness of the glass ribbon.

### SUMMARY

According to a first aspect A1, a glass forming apparatus comprises a forming body defining a draw plane that extends in a draw direction. An enclosure extends in the draw direction below the forming body. The enclosure comprises a compartment positioned below the forming body in the draw direction. The compartment comprises a cooled wall positioned adjacent to the draw plane. A fluid conduit may be positioned within the compartment and adjacent to the cooled wall. The compartment further comprises an extraction port extending through the cooled wall and positioned in the draw direction from the fluid conduit and an injection port extending through the cooled wall and positioned in the draw direction from the fluid conduit.

A second aspect A2 includes the glass forming apparatus of aspect A1 further comprising a baffle positioned in the draw direction from the compartment.

A third aspect A3 includes the glass forming apparatus of any of aspects A1-A2, wherein the baffle extends toward the draw plane.

A fourth aspect A4 includes the glass forming apparatus of any of aspects A1-A3, wherein the baffle is hingedly attached to the enclosure.

A fifth aspect A5 includes the glass forming apparatus of any of aspects A1-A4 further comprising a thickness control member positioned between the forming body and the compartment, the thickness control member comprising a slide gate and a cooling door positioned in the draw direction from the slide gate.

A sixth aspect A6 includes the glass forming apparatus of any of aspects A1-A5, wherein the injection port is positioned in the draw direction from the extraction port.

A seventh aspect A7 includes the glass forming apparatus of any of aspects A1-A6 further comprising an extraction manifold coupling the extraction port to a low-pressure reservoir.

An eighth aspect A8 includes the glass forming apparatus of any of aspects A1-A7, further comprising an injection manifold coupling the injection port to a high-pressure source.

A ninth aspect A9 includes the glass forming apparatus of the eighth aspect A8, wherein the high-pressure source comprises a heating element.

A tenth aspect A10 includes the glass forming apparatus of any of aspects A1-A9, wherein the injection port comprises a centerline axis that is oriented at an incline with respect to the draw plane and the draw direction.

In an eleventh aspect A11, a glass forming apparatus comprises a forming body defining a draw plane that extends in a draw direction. An actively cooled thermal sink positioned in the draw direction from the forming body. A transition housing wall positioned in the draw direction from the forming body such that the actively cooled thermal sink is positioned between the transition housing wall and the draw plane. The transition housing wall comprises an extraction port positioned in the draw direction from the actively cooled thermal sink and an injection port positioned in the draw direction from the actively cooled thermal sink.

A twelfth aspect A12 includes the glass forming apparatus of aspect A11, further comprising a baffle positioned in the draw direction from the transition housing wall.

A thirteenth aspect A13 includes the glass forming apparatus of any of aspects A11-A12, wherein the baffle extends toward the draw plane.

A fourteenth aspect A14 includes the glass forming apparatus of any of aspects A11-A13, further comprising: an extraction manifold coupling the extraction port to a low-pressure reservoir and an injection manifold coupling the injection port to a high-pressure source.

In a fifteenth aspect A15, a method of forming a glass ribbon, comprises drawing the glass ribbon from a forming body in a draw direction between thickness control members; cooling the glass ribbon; and stabilizing an eddy of airflow that circulates in a partially enclosed region formed by the thickness control members and a baffle positioned in the draw direction from the thickness control members. The eddy of airflow is stabilized by extracting air from the partially enclosed region and injecting air into the partially enclosed region. The air injected into the partially enclosed region is at a temperature greater than a temperature of the air extracted from the partially enclosed region.

A sixteenth aspect A16 includes the method of aspect A15, wherein air is injected into the partially enclosed region through an injection port spaced in the draw direction from an extraction port through which air is extracted from the partially enclosed region.

A seventeenth aspect A17 includes the method of any of aspects A15-A16, wherein air is extracted from the partially enclosed region through an extraction port positioned in the draw direction from the thickness control members.

An eighteenth aspect A18 includes the method of any of aspects A15-A17, wherein the glass ribbon is in a viscous or a viscoelastic state while the glass ribbon is in the partially enclosed region.

A nineteenth aspect A19 includes the method of any of aspects A15-A18, wherein a rate of air injected into the partially enclosed region is 30 pounds per hour or more.

A twentieth aspect A20 includes the method of any of aspects A15-A19, wherein a temperature variation of the air measured at a fixed location in the partially enclosed region is less than 0.4° C. over a time period of 10 seconds.

It is to be understood that both the foregoing general description and the following detailed description are merely exemplary and are intended to provide an overview or framework to understanding the nature and character of the claimed subject matter. The accompanying drawings are included to provide further understanding and are incorporated in and constitute a part of this specification. The drawings illustrate one or more embodiment(s), and together with the description, explain principles and operation of the various embodiments.

### BRIEF DESCRIPTION OF THE DRAWINGS

FIG. 1 is a schematic view of a glass forming apparatus according to one or more embodiments shown and described herein;

FIG. 2 is a side sectional view of a glass forming apparatus according to one or more embodiments shown and described herein; and

FIG. 3 is a side sectional view of a glass forming apparatus according to one or more embodiments shown and described herein.

### DETAILED DESCRIPTION

Reference will now be made in detail to various embodiments of glass forming apparatuses, examples of which are illustrated in the accompanying drawings. Whenever possible, the same reference numerals will be used throughout the drawings to refer to the same or like parts. The components in the drawings are not necessarily to scale, emphasis instead being placed upon illustrating the principles of the exemplary embodiments.

Numerical values, including endpoints of ranges, can be expressed herein as approximations preceded by the term “about,” “approximately,” or the like. In such cases, other embodiments include the particular numerical values. Regardless of whether a numerical value is expressed as an approximation, two embodiments are included in this disclosure: one expressed as an approximation, and another not expressed as an approximation. It will be further understood that an endpoint of each range is significant both in relation to another endpoint, and independently of another endpoint.

Unless otherwise expressly stated, it is in no way intended that any method set forth herein be construed as requiring that its steps be performed in a specific order, nor that with any apparatus specific orientations be required. Accordingly, where a method claim does not actually recite an order to be followed by its steps, or that any apparatus claim does not actually recite an order or orientation to individual components, or it is not otherwise specifically stated in the claims or description that the steps are to be limited to a specific order, or that a specific order or orientation to components of an apparatus is not recited, it is in no way intended that an order or orientation be inferred, in any respect. This holds for any possible non-express basis for interpretation, including: matters of logic with respect to arrangement of steps, operational flow, order of components, or orientation of components, plain meaning derived from grammatical organization or punctuation, and the number or type of embodiments described in the specification.

Directional terms as used herein—for example up, down, right, left, front, back, top, bottom—are made only with reference to the figures as drawn and are not intended to imply absolute orientation.

As used herein, the terms “comprising” and “including,” and variations thereof, shall be construed as synonymous and open ended, unless otherwise indicated.

As used herein, the phrase “actively cooled thermal sink” refers to an apparatus positioned within an environment at an elevated temperature and that absorbs and removes thermal energy from the environment. The actively cooled thermal sink incorporates a heat transfer medium that may be controlled to modulate the rate of thermal energy that is absorbed by the actively cooled thermal sink.

As used herein, “viscoelastic state” refers to a physical state of glass in which the viscosity of the glass is from about 1×10⁸ poise to about 1×10¹⁴ poise.

As used herein, “viscous state” refers to a physical state of glass in which the viscosity of the glass is less than the viscosity of the glass in the viscoelastic state, e.g., less than about 1×10⁸ poise.

As used herein, the singular forms “a,” “an” and “the” include plural referents unless the context clearly dictates otherwise. Thus, for example, reference to “a” component includes aspects having two or more such components, unless the context clearly indicates otherwise.

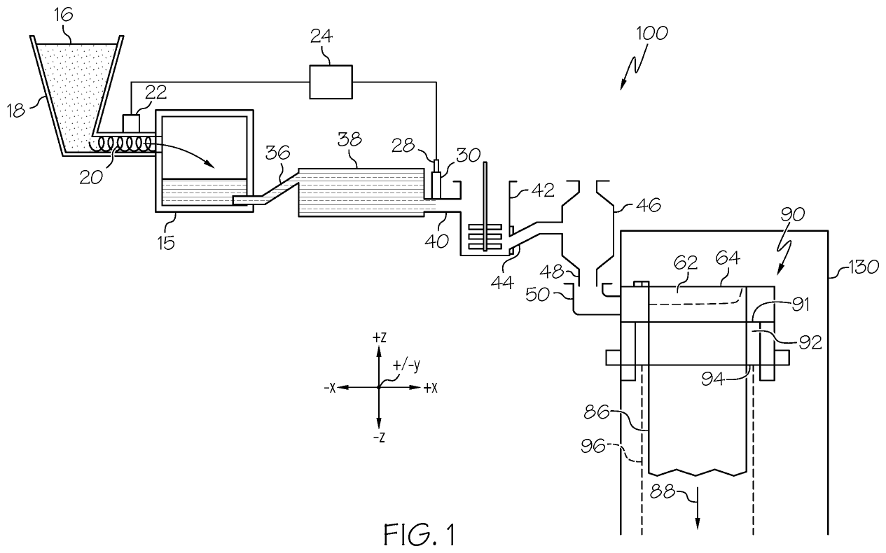

Referring now to FIG. 1, a glass forming apparatus 100 is schematically depicted. As will be described in further detail herein, molten glass flows into and is drawn away from the forming body 90 as a glass ribbon 86. As the glass ribbon 86 is drawn away from the forming body 90, the glass ribbon 86 is cooled and the viscosity of the glass ribbon 86 increases. The increase in viscosity of the glass allows the glass ribbon to sustain pulling forces applied to the glass ribbon to manage the thickness of the glass ribbon. Components of the glass forming apparatus 100 and air that surround the forming body 90 and the glass ribbon 86 regulate the temperature of the molten glass and the glass ribbon 86. Certain glass compositions and/or glass ribbon configurations may have properties that necessitate additional thermal management, such as rapid cooling to decrease the viscosity of the glass ribbon. Cooling the glass ribbon, however, may lead to instabilities in the regions within the glass forming apparatus 100 proximate to the glass ribbon 86. For example, non-uniform airflow or non-uniform temperatures of the air in regions within an enclosure 130 surrounding the glass ribbon 86 can lead to variations in the thickness of the glass ribbon and/or the width of the glass ribbon in the cross-draw direction.

For example, elements of the glass forming apparatus that contribute to thermal management may also aid in manufacturing glass at high throughput rates that correspond to an increase in the mass flow rate of molten glass and the corresponding increased thermal load that should be dissipated within a given time to stabilize the glass ribbon as it is drawn from the forming body. The increased thermal load due to higher throughput rates of the glass necessitates increased heat transfer rates from the glass to maintain equivalent temperatures as compared to conventional, lower throughput rates. However, rapid cooling of the glass ribbon disrupts the flow of air with the glass forming apparatus, potentially leading to defects in the glass ribbon.

As will be discussed in greater detail below, the present disclosure is directed to glass forming apparatuses for forming a glass ribbon that comprise extraction and injection ports to modify temperatures of air in the glass forming apparatus. As noted herein, a large amount of thermal energy is rapidly withdrawn from the molten glass to cool the molten glass. Extraction and injection ports allow air to be exchanged in and out of the glass forming apparatus to prevent the withdrawal of an undesirably large quantity of heat from the air that surrounds the glass ribbon within the enclosure. Limiting the temperature loss of the air in these regions encourages the formation of stable eddies of air, which, in turn, encourages stable cooling of the glass ribbon and mitigates the formation of defects, such as variations in the thickness and/or width of the glass ribbon.

Specifically, embodiments according to the present disclosure comprise extraction ports through which cooled air is removed from the glass forming apparatus and injection ports through which heated air is introduced into the glass forming apparatus. The air injected through the injection ports is at a higher temperature than the air extracted through the extraction ports. The extraction of cooled air and the injection of heated air encourages the formation of stable eddies that circulate within the glass forming apparatus adjacent to the glass ribbon, thereby mitigating defects in the glass ribbon, such as undesirable variations in the width and/or thickness of the glass ribbon.

Stable eddies of air are driven by convection. The air proximate to the glass ribbon tends to circulate in an upward direction because the air is hotter and less dense than surrounding air, while the air proximate to cooling components, such as cooled walls and/or actively cooled thermal sinks, may tend to circulate in a downward direction because the air is cooler and more dense than surrounding air. Further reducing the temperature of the air adjacent to the glass ribbon, such as by rapidly cooling the glass, may upset the stability of the eddies. In particular, cooled air may be too dense to circulate in an upward direction. In such cases, the stability of the eddies within the glass forming apparatus is interrupted, and the airflow in the regions proximate to the glass ribbon does not flow uniformly. Instability of the airflow in these regions may lead to temperature variation along the glass ribbon, which, in turn, may lead to defects in the glass ribbon, such as thickness variations and/or variations in the width of the glass ribbon in the cross-draw direction. Such defects are caused by irregular or non-uniform cooling of the glass ribbon.

Embodiments of the glass forming apparatuses described herein comprise a forming body defining a draw plane that extends in a draw direction. The glass forming apparatus comprises thickness control members spaced apart from the draw plane. At least a portion of the thickness control members are positioned below the forming body in the draw direction. In at least one embodiment, the glass forming apparatus further comprises actively cooled thermal sinks in the form of compartments positioned in the draw direction from the thickness control members and the forming body. The compartments comprise cooled walls adjacent to the draw plane, extraction ports extending through the cooled walls of the compartments and injection ports extending through the cooled walls of the compartments. The glass forming apparatus may further include baffles positioned in the draw direction from the compartments.

Molten glass is introduced to the forming body and drawn from the forming body as a glass ribbon that travels in a draw direction away from the forming body. The glass ribbon dissipates heat to the cooled walls of the compartments. Air in the region proximate to the compartments is cooled by the cooled walls. Cooled air is extracted through the extraction ports and heated air is injected through the injection ports. The heated air mixes with the remaining air in the glass forming apparatus. By maintaining the air in the region proximate to the cooled walls at a suitable temperature and density, the air in the region proximate to the compartments can form stable eddies that circulate proximate to the glass ribbon, thereby providing stable thermal conditions around the glass ribbon while the glass ribbon cools. This mitigates the occurrence of defects in the glass ribbon, such as variations in the width and/or thickness of the glass ribbon.

The foregoing embodiment of a glass forming apparatus, as well as other embodiments of glass forming apparatuses which include injection ports for injecting heated air into the glass forming apparatus and extraction ports for extracting cooled air from the glass forming apparatus, and methods of using the same, will be described in further detail herein with specific reference to the appended drawings.

While embodiments according to the present disclosure are generally described with respect to a fusion draw process in which a glass ribbon is drawn downward from a forming body, elements of the glass forming apparatus described herein may be incorporated into a variety of glass forming processes, for example, slot forming, updraw, or float processes, without regard to the direction that the glass ribbon is drawn.

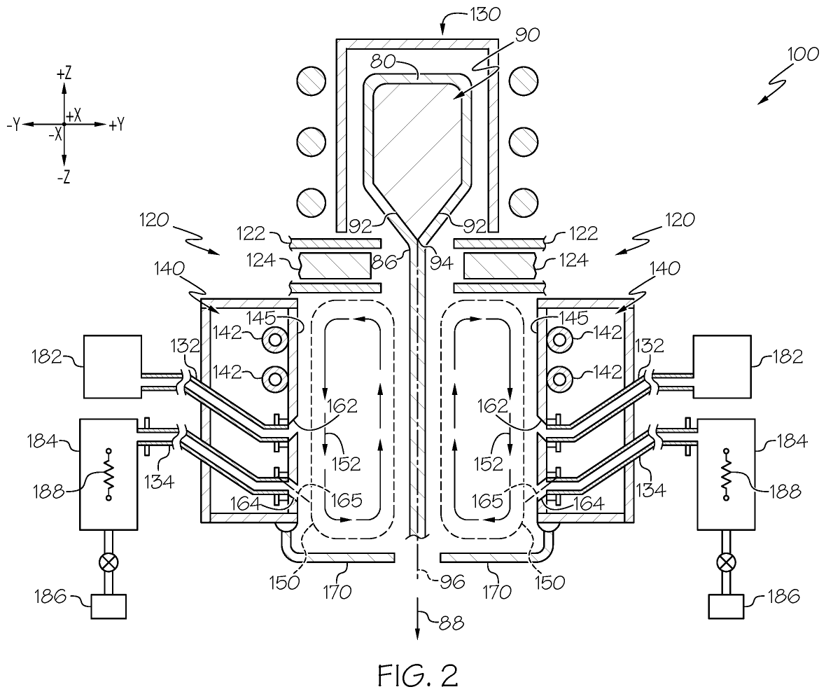

Referring now to FIGS. 1 and 2, one embodiment of a glass forming apparatus 100 for making glass articles, such as a glass ribbon 86, is schematically depicted. The glass forming apparatus 100 may generally comprise a melting vessel 15 configured to receive batch material 16 from a storage bin 18. The batch material 16 can be introduced to the melting vessel 15 by a batch delivery device 20 powered by a motor 22. An optional controller 24 may be provided to activate the motor 22 and a molten glass level probe 28 can be used to measure the glass melt level within a standpipe 30 and communicate the measured information to the controller 24.

The glass forming apparatus 100 can also comprise a fining vessel 38 coupled to the melting vessel 15 by way of a first connecting tube 36. A mixing vessel 42 is coupled to the fining vessel 38 with a second connecting tube 40. A delivery vessel 46 is coupled to the mixing vessel 42 with a delivery conduit 44. As further illustrated, a downcomer 48 is positioned to deliver molten glass from the delivery vessel 46 to a forming body inlet 50 of a forming body 90. The forming body 90 may be positioned within an enclosure 130. The enclosure 130 may extend in the draw direction 88 (i.e., the downward vertical direction corresponding to the −Z direction in the coordinate axes depicted in the figures). In the embodiments shown and described herein, the forming body 90 is a fusion-forming vessel. Specifically, the forming body 90 has a trough 62 and a pair of opposed weirs 64 (one shown in FIG. 1) bounding the trough 62. A pair of vertical surfaces extend in the downward vertical direction from the pair of weirs 64 to a pair of break lines 91 (one shown in FIG. 1). A pair of opposed converging surfaces 92 (one shown in FIG. 1) extend in the downward vertical direction from the pair of break lines 91 and converge at a root 94 of the forming body 90.

While FIG. 1 depicts a fusion-forming vessel as the forming body 90, other forming bodies are compatible with the methods and apparatuses described herein, including, without limitation, slot-draw forming bodies and the like.

In operation, molten glass from the delivery vessel 46 flows through the downcomer 48, the forming body inlet 50 and into the trough 62. Molten glass in the trough 62 flows over the pair of weirs 64 bounding the trough 62 and down (−Z direction) the pair of vertical surfaces extending from pair of weirs 64 and down the pair of converging surfaces 92 extending from the pair of break lines 91 before converging at the root 94 to form a glass ribbon 86.

Referring now to FIG. 2, molten glass 80 flows in streams along the converging surfaces 92 of the forming body 90. The streams of molten glass 80 are brought together and fuse below the root 94. The glass is drawn from the forming body 90 in a draw direction 88 as a glass ribbon 86. The forming body 90 defines a draw plane 96 that extends from the root 94 in the draw direction 88. The glass ribbon 86 is drawn from the forming body 90 on the draw plane 96. In the embodiment depicted in FIG. 2, the draw plane 96 is generally parallel to a vertical plane (i.e., parallel to the X-Z plane of the coordinate axes depicted in the figures).

The molten glass 80 increases in viscosity as the molten glass 80 cools from a viscous state to a viscoelastic state and eventually to an elastic state. The viscosity of the glass determines, for example, whether the glass can sustain pulling forces applied to the glass by pulling rollers positioned below the root. Glass compositions with relatively low viscosity at temperatures at which the glass is drawn from the forming body 90 may necessitate reduced pulling force that can be sustained by the glass due to the relatively low viscosity. Embodiments according to the present disclosure comprise elements for stabilizing the cooling of the glass ribbon 86 (thereby increasing the viscosity) while mitigating the formation of defects in the glass ribbon, such as variations in the width and/or thickness of the glass ribbon.

Still referring to FIG. 2, the glass forming apparatus 100 further comprises thickness control members 120 extending through the enclosure 130. The thickness control members 120 generally extend parallel to the draw plane 96 in the width direction of the draw plane 96 (i.e., in the +/−X directions of the coordinate axes depicted in the figures) and are spaced apart from the draw plane 96 in directions orthogonal to the draw plane (i.e., in the +/−Y directions of the coordinate axes depicted in the figures). At least a portion of the thickness control members 120 are positioned below the root 94 of the forming body 90 in the draw direction 88. In the embodiment depicted in FIG. 2, the thickness control members 120 comprise slide gates 122 positioned proximate to the root 94 of the forming body 90 and cooling doors 124 positioned in the draw direction 88 from the slide gates 122 (i.e., the cooling doors 124 are positioned below of the slide gates 122 in the draw direction 88).

The enclosure 130 of the glass forming apparatus 100 also comprises a pair of compartments 140 located on opposing sides of the draw plane 96 below the forming body 90 and below the thickness control members 120 in the draw direction 88. The compartments 140 extend through the walls of the enclosure 130 and comprise cooled walls 145 positioned adjacent to the draw plane 96. That is, the compartments function as actively cooled thermal sinks. The cooled walls 145 of each compartment 140 are parallel to the draw plane 96 and spaced apart from the draw plane 96, as depicted in FIG. 2.

Each compartment 140 comprises at least one extraction port 162 that extends through the cooled wall 145 of the compartment 140. Each compartment 140 also comprises at least one injection port 164 that extends through the cooled wall 145 of the compartment 140.

In the embodiment depicted in FIG. 2, the injection ports 164 are positioned downstream from the extraction ports 162 in the draw direction 88. However, other embodiments are contemplated and possible, such as embodiments in which the extraction ports 162 are positioned downstream from the injection ports 164 in the draw direction 88.

In embodiments, the injection ports 164 may be oriented such that a centerline axis 165 of the injection ports 164 are directed at a downward incline relative to both the draw plane 96 and the draw direction 88, as depicted in FIG. 2. This orientation of the injection ports 164 relative to the draw plane 96 and the draw direction 88 may aid in establishing the formation of stable eddies (indicated by arrows 152) within the enclosure 130 below the thickness control members 120. Specifically, the angled orientation of the injection ports 164 encourages heated air introduced into the glass forming apparatus 100 to form stable eddies 152 which circulate adjacent to the glass ribbon 86 drawn on the draw plane 96.

The compartments 140 further comprise extraction manifolds 132. The extraction manifolds 132 extend through the compartments 140 and couple the extraction ports 162 of the cooled walls 145 of the compartments 140 to low-pressure reservoirs 182. For example, the extraction manifolds 132 may couple the extraction ports 162 of the compartments 140 to reservoirs that are held at a partial vacuum such that the pressure in the low-pressure reservoirs 182, the extraction manifolds 132, and the extraction ports 162 is less than static pressure in regions of the glass forming apparatus 100 proximate to the extraction ports 162, thereby enabling air within the enclosure 130 to be withdrawn from the enclosure 130.

In the embodiments described herein, the compartments 140 further comprise injection manifolds 134. The injection manifolds 134 extend through the compartments 140 and couple the injection ports 164 of the cooled walls 145 of the compartments 140 to high-pressure sources 184. For example, the injection manifolds 134 may couple the injection ports to pumps 186. The pumps 186 provide air to the enclosure 130 through the injection manifolds 134 and the injection ports 164 by maintaining the pressure in the injection manifolds 134 above the static pressure in regions of the glass forming apparatus 100 proximate to the injection ports 164. The pumps 186 include heating elements 188 that heat air directed into the injection manifold 134 and the injection ports 164.

The glass forming apparatus 100 further comprises baffles 170 positioned in the draw direction from the compartments 140. During steady state operation of the glass forming apparatus 100, the baffles 170 are extended toward the draw plane 96 thereby forming partially enclosed regions 150 along the draw plane 96 between the thickness control members 120 and the baffles 170. The baffles 170 (when extended toward the draw plane 96) facilitate establishing stable eddies of air in the partially enclosed regions 150 bounded on two sides by the baffles 170 and the thickness control members 120. The baffles 170 also act as radiation shields to prevent components of the glass forming apparatus 100 that are positioned in the draw direction 88 from the baffles 170 from being heated. In various embodiments, the baffles 170 are hingedly attached to the enclosure 130 and/or the compartments 140, such that the baffles 170 can be pivoted away from the draw plane 96. For example, the baffles 170 may be pivoted away from the draw plane 96 during start-up of the glass forming apparatus 100 to allow the glass ribbon 86 to be threaded through the glass forming apparatus 100 along the draw plane 96. Thereafter, the baffles 170 may be pivoted toward the draw plane 96 once steady-state operation of the glass forming apparatus 100 is achieved.

The thickness control members 120, the compartments 140, and the baffles 170 extend in a direction corresponding to the width of the glass ribbon 86, which is at an orientation perpendicular to the view shown in FIG. 2 (i.e., the width of the glass ribbon extends in the +/−X direction of the coordinate axes depicted in the figures). A plurality of extraction ports 162 and a plurality of injection ports 164 are also arranged along the enclosures 130 in a direction corresponding to the width of the glass ribbon 86 (i.e., the +/−X direction of the coordinate axes depicted in the figures). Alternatively, each compartment 140 may include a single extraction port 162 and a single injection port 164, both of which extend across the compartment in a direction corresponding to the width of the glass ribbon 86. The thickness control members 120, the compartments 140, and the baffles 170 are spaced apart from the draw plane 96 such that these elements do not contact either the molten glass 80 or the glass ribbon 86 during operation of the glass forming apparatus 100.

In embodiments, the cooled walls 145 of the compartments 140 may be cooled by directing a cooling fluid, such as air, through each compartment 140. In some embodiments, such as the embodiment depicted in FIG. 2, the compartments 140 further include active cooling elements for cooling the cooled walls 145. For example, in embodiments, the compartments 140 may further include fluid conduits 142 extending generally parallel to a width of the glass ribbon 86. The fluid conduits 142 may be positioned within each compartment 140 and may be positioned adjacent to the cooled walls 145 such that the fluid conduits 142 are in thermal communication with the cooled walls 145 thereby facilitating the dissipation of heat from within the glass forming apparatus 100 through the cooled walls 145. In embodiments, the fluid conduits 142 may be positioned within each compartment 140 in direct contact with the cooled walls 145. In embodiments, the fluid conduits 142 are positioned in the compartments 140 such that the extraction ports 162 and the injection ports 164 are located downstream of the fluid conduits 142 in the draw direction 88. A cooling fluid is directed through the fluid conduits 142. The cooling fluid maintains the temperature of the fluid conduits 142 and, in turn, the cooled walls 145 as heat from the glass ribbon 86 is dissipated into the cooling fluid through the cooled walls 145 of the compartments 140. Accordingly, by flowing cooling fluid through the compartments 140 (either through the compartments 140 and/or through fluid conduits 142 positioned within the compartments 140), heat can be removed from the glass forming apparatus 100 through the compartments 140.

In some embodiments, the cooling fluid directed through the fluid conduits 142 and the flow rate of the cooling fluid can be selected based on the thermal properties of the cooling fluid as well as the amount of heat that is to be dissipated from the glass forming apparatus 100. In general, cooling fluids may be selected based on the heat capacity of the cooling fluids. In general, liquid cooling fluids may be preferred, as the density of the liquid tends to result in high thermal capacity. Examples of acceptable cooling fluids include, for illustration and not limitation, air, water, nitrogen, water vapor, or a commercially available refrigerant. In some embodiments, the cooling fluid and the flow rate of the cooling fluid may be selected such that the cooling fluid does not undergo a phase change when passing through the fluid conduit. In some embodiments, the cooling fluid may be cycled through the fluid conduits 142 and through a cooling system (not shown) to maintain the temperature of the fluid in a closed loop system. In other embodiments, the fluid may be discharged after passing through the fluid conduits 142.

As noted herein, the thickness control members 120 and the baffles 170 define partially enclosed regions 150 of the glass forming apparatus 100 proximate to the draw plane 96. When glass is produced in the glass forming apparatus 100, the glass ribbon 86 is drawn from the forming body 90 and past the thickness control members 120, the compartments 140, and the baffles 170. The glass ribbon 86 is at a higher temperature than the cooled walls 145 of the compartments 140. Accordingly, heat from the glass ribbon 86 is dissipated into the compartments 140 through the cooled walls 145 and carried away from the compartments 140 by the cooling fluid. Because of the large temperature differential between the glass ribbon 86 and the cooled walls 145 of the compartments 140, substantial heat can be dissipated from the glass ribbon 86 in a short distance along the draw direction 88. Dissipating a large amount of heat may be beneficial for glass manufacturing operations in which a rapid decrease in temperature of the glass ribbon 86 is desired.

In the embodiments described herein, eddies 152 of air (i.e., circulating currents of air) form within the partially enclosed regions 150 between the thickness control members 120 and the baffles 170. Air positioned proximate to the glass ribbon 86 is generally hotter than air positioned farther from the glass ribbon 86, such as air adjacent to the compartments 140. The variation in temperature of the air corresponds to a variation in the density of the air, with the warmer air having a lower density and therefore more buoyancy than the cooler air. The warmer, lower density air tends to circulate in an upward direction (opposite the direction of gravity) while the cooler, higher density air tends to circulate in a downward direction (following the direction of gravity). In the depicted embodiment, the draw direction 88 is generally aligned with the direction of gravity. However, the draw direction may vary from the direction of gravity based on particular glass forming methods.

The eddies 152 of air that circulate within the partially enclosed region 150 are driven by convection. Instability in the convection that drives the eddies 152 may cause an undesirable variation in the temperature of the glass ribbon 86. Specifically, variations in the temperature of the glass ribbon 86 correspond to variations in the viscosity of the glass ribbon 86. Such variations in viscosity are undesirable, particularly when the glass is in a viscous or viscoelastic state. Variations in the viscosity of the glass ribbon 86 in such states may make it difficult to maintain the thickness of the glass ribbon 86 and/or the width of the glass ribbon 86 as it is drawn from the forming body 90. Accordingly, instability of the eddies 152 of air that circulate within the partially enclosed regions 150 are undesired.

Without wishing to be bound by theory, it is believed that a large differential in temperature between the glass ribbon 86 and the surfaces of the glass forming apparatus 100 that surround the glass ribbon 86 introduces greater instability in the eddies 152. By extracting air cooled by the cooled walls 145 of the compartments 140 with the extraction ports 162 and injecting heated air at the injection ports 164 as the glass ribbon 86 is drawn through the glass forming apparatus 100, the air within the partially enclosed region 150 surrounding the glass ribbon 86 can be maintained at or close to a targeted temperature. That is, by using the injection ports 164 and the extraction ports 162 to inject heated air and extract cooled air, respectively, the temperature (and density) of the air within the partially enclosed region 150 can be controlled to increase the stability of the eddies 152 and improve stability of the glass manufacturing process.

Accordingly, in the embodiments described herein, the injection ports 164 and the extraction ports 162 are used to inject heated air and extract cooled air, respectively, into the glass forming apparatus 100 as the glass ribbon 86 is drawn through the glass forming apparatus 100 from the forming body 90 and past the thickness control members 120, compartments 140, and the baffles 170. The injection of heated air, combined with the extraction of cooled air, encourages the formation of stable eddies 152 in the partially enclosed regions 150 adjacent to the glass ribbon 86 and mitigates variations in the temperature of the glass ribbon 86 which, in turn, decreases or mitigates variations in the thickness and/or width of the glass ribbon 86.

Stability of the eddies 152 may be determined by measuring the temperature of the air in the partially enclosed regions 150. A stable eddy 152 exhibits a peak-to-peak temperature variation of air measured at a fixed location in the partially enclosed region 150 of less than or equal to 0.4° C. over a time period of 10 seconds. In some embodiments, the peak-to-peak temperature variation of air measured at a fixed location in the partially enclosed region 150 is less than or equal to 0.2° C. over a time period of ten seconds. In some embodiments, the peak-to-peak temperature variation of air measured at a fixed location in the partially enclosed region 150 is less than or equal to 0.1° C. over a time period of 10 seconds.

Increased flow rates of air extracted out of and injected into the partially enclosed region 150 through the extraction ports 162 and injection ports 164, respectively, may increase the stability of the eddies 152. In embodiments, the rate of air extracted from and injected into the partially enclosed region 150 may be about 15 pounds per hour or more, for example, 30 pounds per hour or more, or even 60 pounds per hour or more, to increase the stability of the eddies 152.

Extracting cool air and injecting heated air into the partially enclosed regions 150 through the extraction ports 162 and injection ports 164, respectively, may slightly reduce the rate of cooling of the glass ribbon 86 within the partially enclosed regions 150 while encouraging the formation of stable eddies 152, thereby increasing the stability of the glass drawing process while mitigating variations in the thickness and/or width of the glass ribbon 86.

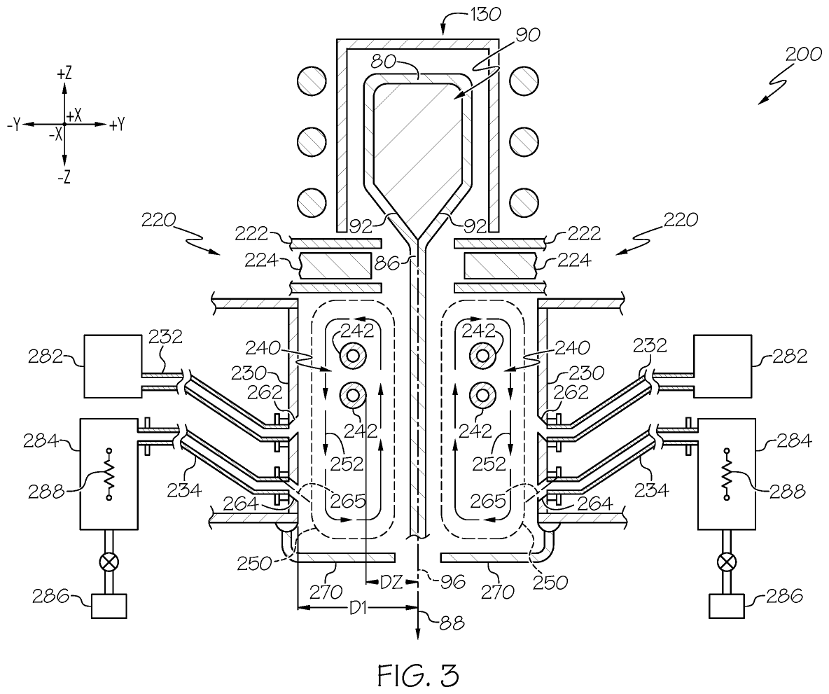

Referring now to FIG. 3, another embodiment of a glass forming apparatus 200 is schematically depicted. In this embodiment, the glass forming apparatus 200 includes a forming body 90 positioned within an enclosure 130 as described hereinabove with respect to FIGS. 1 and 2. The forming body 90 may comprise converging surfaces 92 that terminate at a root 94. Molten glass 80 flows in streams along the converging surfaces 92 of the forming body 90. The streams of molten glass 80 are brought together and fuse below the root 94. The glass is drawn from the forming body 90 in a draw direction 88 along draw plane 96 as a glass ribbon 86, as described hereinabove with respect to FIGS. 1 and 2.

The glass forming apparatus 200 further comprises thickness control members 220 extending through the enclosure 130. The thickness control members 220 generally extend parallel to the draw plane 96 (i.e., in the +/−X directions of the coordinate axes depicted in the figures) and are spaced apart from the draw plane 96 in directions orthogonal to the draw plane (i.e., in the +/−Y directions of the coordinate axes depicted in the figures). At least a portion of the thickness control members 220 are positioned below the root 94 of the forming body 90 in the draw direction 88. In the embodiment depicted in FIG. 3, the thickness control members 220 comprise slide gates 222 positioned proximate to the root 94 of the forming body 90 and cooling doors 224 positioned in the draw direction 88 from the slide gates 222 (i.e., the cooling doors 224 are positioned below the slide gates 222 in the draw direction 88).

The glass forming apparatus 200 also comprises actively cooled thermal sinks 240 positioned downstream from the thickness control members 220 in the draw direction 88.

The enclosure 130 of the glass forming apparatus 200 further comprises transition housing walls 230 positioned below the forming body 90 and the thickness control members 220 in the draw direction 88. The transition housing walls 230 are positioned such that the actively cooled thermal sinks 240 are disposed between the transition housing walls 230 and the draw plane 96. Specifically, the transition housing walls 230 are spaced a distance D1 from the draw plane 96 that is greater than a distance D2 by which the actively cooled thermal sinks 240 are spaced from the draw plane 96.

In the embodiments described herein, each of the transition housing walls 230 comprises at least one extraction port 262 that extends through the transition housing wall 230. The extraction ports 262 are positioned downstream from the forming body 90 and the actively cooled thermal sinks 240 in the draw direction 88. Each of the transition housing walls 230 also comprises at least one injection port 264. Like the extraction ports 262, the injection ports 264 are positioned downstream from the forming body and the actively cooled thermal sinks 240 in the draw direction 88. In some embodiments, the injection ports 264 are positioned downstream from the extraction ports 262 in the draw direction 88, as depicted in FIG. 3. However, other embodiments are contemplated and possible, including embodiments in which the extraction ports 262 are positioned downstream from the injection ports 264 in the draw direction.

In embodiments, the injection ports 264 may be oriented such that a centerline axis 265 of the injection ports 264 are directed at a downward incline toward both the draw plane 96 and the draw direction 88, as depicted in FIG. 3. This orientation of the injection ports 164 relative to the draw plane 96 and the draw direction 88 may aid in establishing the formation of stable eddies (indicated by arrows 252) within the enclosure 130 below the thickness control members 220. Specifically, the angled orientation of the injection ports 264 encourages heated air introduced into the glass forming apparatus 200 to form stable eddies 252 which circulate adjacent to the glass ribbon 86 drawn on the draw plane 96.

The transition housing walls 230 further comprise extraction manifolds 232. The extraction manifolds 232 couple the extraction ports 262 of the transition housing walls 230 to low-pressure reservoirs 182. For example, the extraction manifolds 232 may couple the extraction ports 262 of the transition housing walls 230 to reservoirs that are held at a partial vacuum such that the pressure in the low-pressure reservoirs 282, the extraction manifolds 232, and the extraction ports 262 is less than static pressure in regions of the glass forming apparatus 200 proximate to the extraction ports 262, thereby enabling air within the enclosure 130 to be withdrawn from the enclosure 130.

In the embodiments described herein, the transition housing walls 230 further comprise injection manifolds 234. The injection manifolds 234 extend through the transition housing walls 230 and couple the injection ports 264 to high-pressure sources 284. For example, the injection manifolds 234 may couple the injection ports to pumps 286. The pumps 286 provide air to the enclosure 130 through the injection manifolds 234 and the injection ports 264 by maintaining the pressure in the injection manifolds 234 and the injection ports 264 above the static pressure in regions of the glass forming apparatus 200 proximate to the injection ports 264. The pumps 286 may include heating elements 288 that heats air directed into the injection manifold 234 and the injection ports 264.

The glass forming apparatus 200 further comprises baffles 270 positioned in the draw direction from the transition housing walls 230 and the actively cooled thermal sinks 240. During steady state operation of the glass forming apparatus 200, the baffles 270 are extended toward the draw plane 96 thereby forming partially enclosed regions 250 along the draw plane 96 between the thickness control members 220 and the baffles 270. The baffles 270 (when extended toward the draw plane 96) facilitate establishing stable eddies of air in the partially enclosed regions 250 between the baffles 270 and the thickness control members 220. In various embodiments, the baffles 270 are hingedly attached to the enclosure 130 and/or the transition housing walls 230, such that the baffles 270 can be pivoted away from the draw plane 96. The baffles 270 may be pivoted away from the draw plane 96 during start-up of the glass forming apparatus 200 to allow the glass ribbon 86 to be threaded through the glass forming apparatus 200 along the draw plane 96. Thereafter, the baffles 270 may be pivoted toward the draw plane 96 once steady-state operation of the glass forming apparatus 100 is achieved.

The thickness control members 220, the transition housing walls 230, the actively cooled thermal sinks 240, and the baffles 270 extend in a direction corresponding to the width of the glass ribbon 86, which is at an orientation perpendicular to the view shown in FIG. 3. A plurality of extraction ports 262 and a plurality of injection ports 264 are also arranged along the transition housing walls in a direction corresponding to the width of the glass ribbon 86. Alternatively, each transition housing wall 230 may include a single extraction port 262 and a single injection port 264, both of which extend across the transition housing walls 230 in a direction corresponding to the width of the glass ribbon 86. The thickness control members 220, the transition housing walls 230, the actively cooled thermal sinks 240 and the baffles 270 are spaced apart from the draw plane 96 such that these elements do not contact either the molten glass 80 or the glass ribbon 86.

Still referring to FIG. 3, the actively cooled thermal sinks 240 incorporate active cooling elements, for example, a fluid conduit 242 extending generally parallel to a width of the glass ribbon 86. A cooling fluid can be directed through the fluid conduit 242. The cooling fluid maintains the temperature of the fluid conduit 242, and heat from the glass ribbon 86 may be dissipated into the cooling fluid. By flowing the cooling fluid out of the fluid conduit 242, heat can be removed from the glass forming apparatus 200. In the embodiment depicted in FIG. 3, the actively cooled thermal sinks 240 are adjacent to and in view of the transition housing walls 230. The actively cooled thermal sinks 240, therefore, also provide cooling to the transition housing walls 230.

In some embodiments, the cooling fluid directed through the fluid conduits 242 and the flow rate of the cooling fluid can be selected based on the thermal properties of the cooling fluid as well as the amount of heat that is to be dissipated from the glass forming apparatus 200. In general, cooling fluids may be selected based on the heat capacity of the cooling fluids. In general, liquid cooling fluids may be preferred, as the density of the liquid tends to result in high thermal capacity. Examples of acceptable cooling fluids include, for illustration and not limitation, air, water, nitrogen, water vapor, or a commercially available refrigerant. In some embodiments, the cooling fluid and the flow rate of the cooling fluid may be selected such that the cooling fluid does not undergo a phase change when passing through the fluid conduit. In some embodiments, the cooling fluid may be cycled through the fluid conduits 242 and through a cooling system (not shown) to maintain the temperature of the fluid in a closed loop system. In other embodiments, the fluid may be discharged after circulation through the fluid conduits 242.

As noted herein, the thickness control members 220 and the baffles 270 define partially enclosed regions 250 of the glass forming apparatus 200 proximate to the draw plane 96. When glass is produced in the glass forming apparatus 200, the glass ribbon 86 is drawn from the forming body 90 and past the thickness control members 220, the transition housing walls 230, the actively cooled thermal sinks 240, and the baffles 270. The glass ribbon 86 is at a higher temperature than the actively cooled thermal sinks 240. Accordingly, the glass ribbon 86 dissipates heat to the actively cooled thermal sinks 240 by radiation heat transfer. Because of the large temperature differential between the glass ribbon 86 and the actively cooled thermal sinks 240, substantial heat can be dissipated by the glass ribbon 86 in a short distance along the draw direction 88. Dissipating a large amount of heat may be beneficial for glass manufacturing operations in which a rapid decrease in temperature of the glass ribbon 86 is targeted.

Eddies 252 of air (i.e., circulating currents of air) form within the partially enclosed regions 250. Air positioned proximate to the glass ribbon 86 is generally hotter than air positioned farther from the glass ribbon 86, such as air adjacent to the transition housing walls 230. The variation in the temperature of the air corresponds to a variation in the density of the air, with the warmer air having a lower density and therefore more buoyancy than the cooler air. The warmer, lower density air tends to circulate in an upward direction (opposite the direction of gravity) while the cooler, higher density air tends to circulate in a downward direction (following the direction of gravity). In the depicted embodiment, the draw direction 88 is generally aligned with the direction of gravity. However, the draw direction may vary from the direction of gravity based on particular glass forming methods.

The eddies 252 of air that circulate within the partially enclosed regions 250 are driven by convection. Instability in the convection that drives the eddies 252 may cause undesirable variations in the temperature of the glass ribbon 86. Specifically, the variation in temperature of the glass ribbon 86 corresponds to variations in the viscosity of the glass ribbon 86. Such variations in viscosity are undesirable, particularly when the glass is in a viscous or viscoelastic state. Variations in viscosity of the glass ribbon 86 in such states may make it difficult to maintain the thickness and/or width of the glass ribbon 86 as it is drawn from the forming body 90. Accordingly, instabilities of the eddies 252 of air that circulate within the partially enclosed regions 250 are undesired.

Without wishing to be bound by theory, it is believed that a large differential in temperature between the glass ribbon 86 and the surfaces of the glass forming apparatus 200 and air that surround the glass ribbon 86 introduces greater instability in the eddies 252. By extracting air cooled by the actively cooled thermal sinks 240 with the extraction ports 262 and injecting heated air with the injection ports 264 as the glass ribbon 86 is drawn through the glass forming apparatus 100, the air within the partially enclosed region 250 can be maintained at or close to a targeted temperature. That is, by using the injection ports 264 and the extraction ports 262 to inject heated air and extract cooled air, respectively, the temperature (and density) of the air within the partially enclosed region 250 can be controlled to increase the stability of the eddies 252 and improve stability of the glass manufacturing process.

Accordingly, in the embodiments described herein, the injection ports 264 and the extraction ports 262 are used to inject heated air and extract cooled air, respectively, into the glass forming apparatus 200 as the glass ribbon 86 is drawn through the glass forming apparatus 200 from the forming body 90 and past the thickness control members 220, the transition housing walls 230, the actively cooled thermal sinks 240, and the baffles 270. The injection of heated air, combined with the extraction of cooled air, encourages the formation of stable eddies 252 in the partially enclosed regions 250 adjacent to the glass ribbon 86 and mitigates variations in the temperature of the glass ribbon 86 which, in turn, decreases or mitigates variations in the thickness and/or width of the glass ribbon 86.

Stability of the eddies 252 may be determined by measuring the temperature of the air in the partially enclosed regions 250. A stable eddy 252 exhibits a peak-to-peak temperature variation of air measured at a fixed location in the partially enclosed region 250 of less than or equal to 0.4° C. over a time period of 10 seconds. In some embodiments, the peak-to-peak temperature variation of air measured at a fixed location in the partially enclosed region 250 is less than or equal to 0.2° C. over a time period of ten seconds. In some embodiments, the peak-to-peak temperature variation of air measured at a fixed location in the partially enclosed region 250 is less than or equal to 0.1° C. over a time period of 10 seconds.

Increased flow rates of air extracted out of and injected into the partially enclosed region 250 through the extraction ports 262 and injection ports 264, respectively, may increase the stability of the eddies 252. In embodiments, the rate of air extracted from and injected into the partially enclosed region 250 may be about 15 pounds per hour or more, for example, 30 pounds per hour or more, or even 60 pounds per hour or more, to increase the stability of the eddies 252.

Extracting cooler air and injecting heated air into the partially enclosed region 250 through the extraction ports 262 and injection ports 264, respectively, may slightly reduce the rate of cooling of the glass ribbon 86 within the partially enclosed regions 250 while encouraging the formation of stable eddies 252, thereby increasing the stability of the glass drawing process while mitigating variations in the thickness and/or width of the glass ribbon 86.

It should now be understood that glass forming apparatuses according to the present disclosure utilize extraction ports to extract cooled air from the glass forming apparatus and injection ports to inject heated air into the glass forming apparatus to improve the stability of air eddies formed within the glass forming apparatus. Specifically, the heated air mixes with the remaining air in the glass forming apparatus and maintains the air within the glass forming apparatus at a suitable temperature and density, thereby promoting the formation of stable eddies proximate to the glass ribbon. The formation of stable eddies proximate the glass ribbon mitigates defects in the glass ribbon, such as variations in the thickness and width of the glass ribbon.

It will be apparent to those skilled in the art that various modifications and alterations can be made to embodiments of the present disclosure without departing from the scope and spirit of the disclosure. Thus, it is intended that the present disclosure cover the modifications and variations of these embodiments provided they come within the scope of the appended claims and their equivalents.

1. A glass forming apparatus, comprising:
a forming body defining a draw plane that extends in a draw direction; and
an enclosure extending in the draw direction below the forming body, the enclosure comprising a compartment positioned below the forming body in the draw direction, the compartment comprising:
a cooled wall positioned adjacent to the draw plane;
a fluid conduit positioned within the compartment and adjacent to the cooled wall;
an extraction port extending through the cooled wall and positioned in the draw direction from the fluid conduit; and
an injection port extending through the cooled wall and positioned in the draw direction from the fluid conduit.

2. The glass forming apparatus of claim 1, further comprising a baffle positioned in the draw direction from the compartment.

3. The glass forming apparatus of claim 2, wherein the baffle extends toward the draw plane.

4. The glass forming apparatus of claim 2, wherein the baffle is hingedly attached to the enclosure.

5. The glass forming apparatus of claim 1, further comprising a thickness control member positioned between the forming body and the compartment, the thickness control member comprising a slide gate and a cooling door positioned in the draw direction from the slide gate.

6. The glass forming apparatus of claim 1, wherein the injection port is positioned in the draw direction from the extraction port.

7. The glass forming apparatus of claim 1, further comprising an extraction manifold coupling the extraction port to a low-pressure reservoir.

8. The glass forming apparatus of claim 1, further comprising an injection manifold coupling the injection port to a high-pressure source.

9. The glass forming apparatus of claim 8, wherein the high-pressure source comprises a heating element.

10. The glass forming apparatus of claim 1, wherein the injection port comprises a centerline axis oriented at an incline with respect to the draw plane and the draw direction.

11. A glass forming apparatus, comprising:
a forming body defining a draw plane that extends in a draw direction;
an actively cooled thermal sink positioned in the draw direction from the forming body; and
a transition housing wall positioned in the draw direction from the forming body such that the actively cooled thermal sink is positioned between the transition housing wall and the draw plane, the transition housing wall comprising:
an extraction port positioned in the draw direction from the actively cooled thermal sink; and
an injection port positioned in the draw direction from the actively cooled thermal sink.

12. The glass forming apparatus of claim 11, further comprising a baffle positioned in the draw direction from the transition housing wall.

13. The glass forming apparatus of claim 12, wherein the baffle extends toward the draw plane.

14. The glass forming apparatus of claim 11, further comprising:
an extraction manifold coupling the extraction port to a low-pressure reservoir; and
an injection manifold coupling the injection port to a high-pressure source.

15. A method of forming a glass ribbon, comprising:
drawing the glass ribbon from a forming body in a draw direction between thickness control members;
cooling the glass ribbon; and
stabilizing an eddy of airflow that circulates in a partially enclosed region formed by the thickness control members and a baffle positioned in the draw direction from the thickness control members by extracting air from the partially enclosed region and injecting air into the partially enclosed region, wherein the air injected into the partially enclosed region is at a temperature greater than a temperature of the air extracted from the partially enclosed region.

16. The method of claim 15, wherein air is injected into the partially enclosed region through an injection port spaced in the draw direction from an extraction port through which air is extracted from the partially enclosed region.

17. The method of claim 15, wherein air is extracted from the partially enclosed region through an extraction port positioned in the draw direction from the thickness control members.

18. The method of claim 15, wherein the glass ribbon is in a viscous or a viscoelastic state while the glass ribbon is in the partially enclosed region.

19. The method of claim 15, wherein a rate of air injected into the partially enclosed region is 30 pounds per hour or more.

20. The method of claim 15, wherein a temperature variation of the air measured at a fixed location in the partially enclosed region is less than 0.4° C. over a time period of 10 seconds.
